(19) United States
(12) Patent Application Publication
(10) Pub. No.: US 2010/0075630 A1
(43) Pub. Date: Mar. 25, 2010

(54) METHOD AND SYSTEM FOR MANAGING CREDIT FOR SUBSCRIBERS OF MOBILE COMMUNICATIONS SERVICES

(76) Inventors: Russell Tillitt, San Francisco, CA (US); Allan Duckett, San Francisco, CA (US); Bethany Nelson, San Francisco, CA (US); Eric Ortman, Walnut Creek, CA (US); Sherwood Yuen, San Francisco, CA (US)

Correspondence Address: WILSON & HAM, 2530 BERRYESSA ROAD, PMB: 348, SAN JOSE, CA, 95132, US

(21) Appl. No.: 12/565,733

(22) Filed: Sep. 23, 2009

Related U.S. Application Data
(60) Provisional application No. 61/099,512, filed on Sep. 23, 2008.

(51) Int. Cl. H04W 4/24; H04M 11/00; G06Q 20/00; G06Q 50/00; G06Q 10/00; G06Q 30/00; H04W 4/26

(52) U.S. Cl. 455/406; 705/40; 705/10; 705/34; 455/409

(57) ABSTRACT

A technique for managing credit for subscribers of mobile communications services involves using a mobile credit intermediary to manage the credit in a way that makes the credit more fungible than traditional prepaid mobile subscription plans. In an embodiment, the mobile credit intermediary maintains a credit pool that reflects pooled credit of a group of multiple different mobile subscribers and then incrementally purchases, using the credit pool, prepaid mobile minutes in quantities that reflect anticipated consumption of mobile communications services by the group. The incremental purchases are made in increments that are smaller than the balance of the credit pool such that credit remains in individual credit accounts of the mobile subscribers. The credit that remains in the individual credit accounts can be used as a currency for other transactions, for example, for the purchase of goods and services from entities other than the mobile network operator.

### CROSS-REFERENCE TO RELATED APPLICATIONS

This application is entitled to the benefit of provisional U.S. Patent Application Ser. No. 61/099,512, filed Sep. 23, 2009, the disclosure of which is incorporated by reference herein in its entirety.

### FIELD OF THE INVENTION

The present invention generally relates to the fields of telecommunications and data processing, and more particularly to mobile/wireless communications networks and the management of credits for mobile subscribers.

### BACKGROUND OF THE INVENTION

Mobile communications subscription plans can generally be grouped into two types: postpaid plans and prepaid plans (also known as “pay as you go”). In a postpaid subscription scenario, the mobile network operator (MNO) extends a line of credit to a mobile subscriber to use the network for a specific billing period with a specific set of usage terms, which are frequently outlined in a multi-year contract. At the end of the billing period, the mobile network operator bills the mobile subscriber for the actual usage of the network based on those terms. This scenario requires not only that the subscriber be suitable for such a credit extension, but also that there are the necessary credit and billing infrastructures available to determine credit-worthiness and affect the receipt of payment.

Given these limitations, a large portion of consumers cannot utilize mobile communications networks through a postpaid subscription plan. In developed economies, such as the United States and Europe, such consumers often include those who are unable to obtain credit, but also include consumers who prefer to not enter into inflexible, long-term contracts with mobile network operators. In many developing economies in Asia, Africa, and South America, the unavailability of the necessary credit and billing infrastructure can render postpaid plans infeasible for large majorities of potential mobile phone users.

For these consumers, mobile network operators often instead offer prepaid subscription plans. In a prepaid subscription scenario, the mobile subscriber instead purchases mobile network credits, or “prepaid mobile minutes”, in advance of their anticipated actual usage of the network. As of 2009, it is estimated that over two billion mobile subscribers worldwide utilize prepaid mobile subscription plans. Yet, options for these mobile subscribers to conveniently and inexpensively service their mobile phone plans are limited, especially among those that do not have availability of credit cards. As a result, mobile subscribers that utilize prepaid mobile minutes are effectively required to make a direct payment (i.e., a “deposit”) to a mobile network operator, frequently in the form of cash, to prepay for mobile minutes. FIG. 1 illustrates the direct purchase of prepaid mobile minutes by multiple mobile subscribers 10 from a mobile network operator 20. This purchase requires transferring money to the mobile network operator, typically through a point of sale (POS) transaction.

There are mechanisms to redeem these direct purchases of prepaid mobile minutes back into currency. However, the mechanisms are typically limited only to those services that are explicitly provided by the mobile network operator. One such mechanism is through a “reverse billed SMS” (or “premium SMS”), wherein a merchant may post a charge to a mobile subscriber's prepaid phone plan, which deducts the credits in the form of minutes. In other words, a mobile subscriber can pay for products and services with prepaid minutes in this fashion. However, since such merchants must have a relationship with the mobile network operator, either directly or indirectly through a billing intermediary, the mobile subscriber is still limited to only redeem their prepaid cash deposit through proprietary channels. A second example is M-PESA in Kenya (M for mobile, pesa is Swahili for money), which enables mobile subscribers to exchange prepaid mobile minutes and redeem those prepaid mobile minutes directly back into currency, in turn enabling a form of money transfer similar to Western Union. However, transfers are limited to within the confines of the mobile network operator which supports the M-PESA service and there does not appear to be any service that enables a mobile subscriber to purchase, sell, or exchange prepaid mobile minutes in a way that is completely agnostic to the mobile network operator.

Thus, since the only mechanisms to redeem a cash deposit for prepaid mobile minutes are specific to those services that are explicitly provided by the mobile network operators themselves, the act of making a cash deposit to a prepaid mobile account converts an exchangeable commodity, cash, into a proprietary credit, minutes. Furthermore, the deposit is additionally often perishable because prepaid mobile minutes typically have an expiration date.

It is important to note that mobile network operators face challenges in offering a minute exchange service. For example, in most cases, mobile network operators cannot provide full-scale banking services, either due to regulations or other limitations. Therefore, a mobile network operator typically must limit the maximum size of a deposit and place other limitations on how the credits can be used. Indeed, mobile network operators typically have little choice but to treat prepaid mobile minutes as a proprietary credit.

Lastly, even within the postpaid context, there are often elements of the postpaid mobile subscription contract that are in fact prepaid, for example, “rollover minutes”. Just like the prepaid minutes described above, rollover minutes are also prepaid credits which can only be redeemed through proprietary channels provided by the mobile network operator.

### SUMMARY OF THE INVENTION

A technique for managing credit for subscribers of mobile communications services involves using a mobile credit intermediary to manage credit for mobile subscribers in a way that makes the credit more fungible than traditional prepaid mobile subscription plans that are offered by mobile network operators. In an embodiment, the mobile credit intermediary maintains a credit pool that reflects pooled credit of a group of multiple different mobile subscribers and then incrementally purchases, using the credit pool, prepaid mobile minutes in quantities that reflect anticipated consumption of mobile communications services by the group. The incremental purchases of prepaid mobile communications services are made in increments that are smaller than the balance of the credit pool such that credit remains in individual credit accounts of the mobile subscribers. The credit that remains in the individual credit accounts of the mobile subscribers is allowed to be used by the mobile subscribers as a currency for other transactions, for example, for the purchase of goods and services from entities other than the mobile network operator. Because the purchase of prepaid mobile communications services is made in increments that are smaller than the credit pool balance, all of the credit in the individual credit accounts of the mobile subscribers is not immediately transferred to the mobile network operator, thereby leaving the credit outside of the control of the mobile network operator and available to the mobile subscribers as a liquid asset that can be used as currency to buy goods and services other than mobile communications services.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates a conventional technique in which prepaid mobile minutes are purchased by multiple mobile subscribers directly from a mobile network operator.

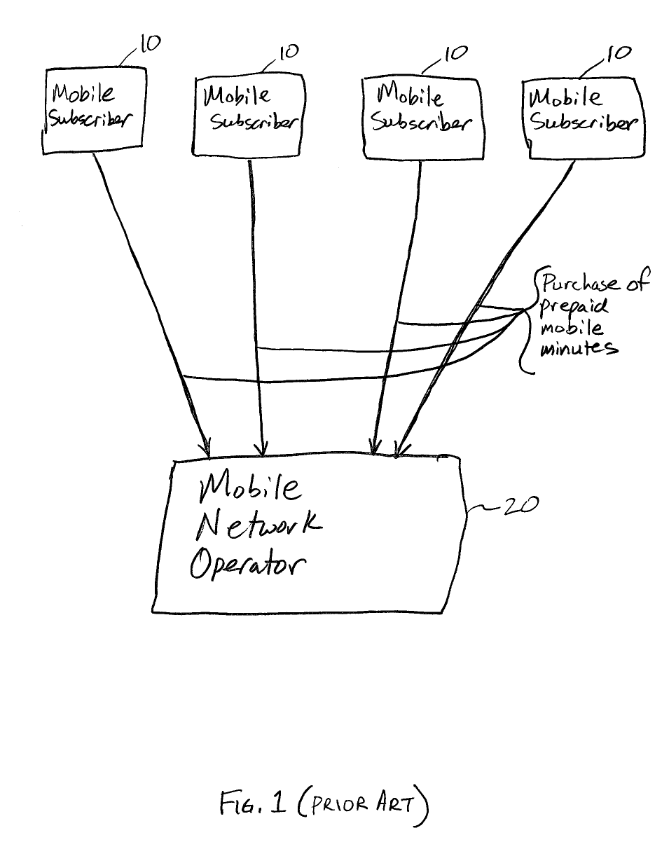

FIG. 2 illustrates a system for managing credit for mobile subscribers in which prepaid mobile communications services are incrementally purchased by a mobile credit intermediary from a credit pool that includes credit from a group of mobile subscribers in accordance with an embodiment of the invention.

FIG. 3 illustrates a credit pool that reflects the pooled credit of multiple different mobile subscribers.

FIG. 4 illustrates an example embodiment of the distribution of credits amongst multiple different mobile subscribers that are associated with the same credit pool.

FIG. 5 illustrates an expanded view of an embodiment of the mobile credit intermediary relative to multiple mobile subscribers and the mobile network operator.

FIG. 6 illustrates a mobile credit intermediary that can be used to purchase prepaid mobile communications services from multiple different mobile network operators.

FIG. 7 depicts a system for mobile communications that includes a mobile credit intermediary in accordance with an embodiment of the invention.

FIG. 8 depicts a computer that can be used to perform operations of a mobile credit intermediary

FIG. 9 is a process flow diagram of a method for managing credit for mobile subscribers in accordance with an embodiment of the invention.

FIG. 10 is a process flow diagram of another method for managing credit for mobile subscribers in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

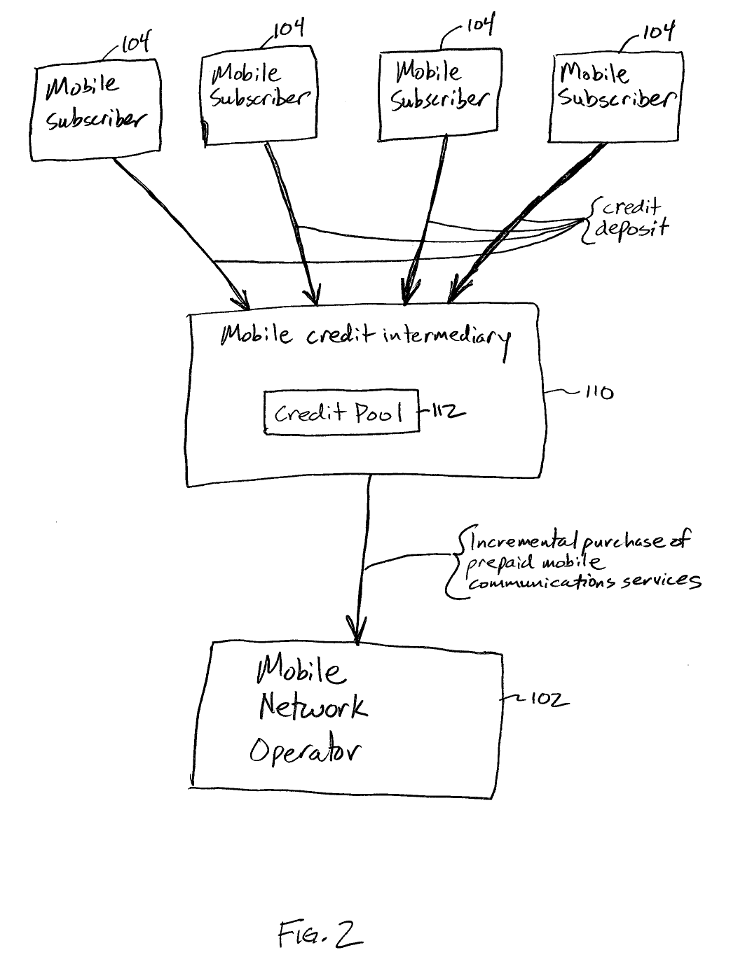

FIG. 2 illustrates a system for managing credit for mobile subscribers in accordance with an embodiment of the invention. The system includes a mobile network operator (MNO) 102, multiple different mobile subscribers 104, and a mobile credit intermediary (MCI) 110. The mobile network operator provides mobile communications services to the mobile subscribers. The mobile communications services may include wireless voice communications services, wireless data communications services, wireless video communications services, and wireless text communications services (i.e., text messaging). The mobile network operator includes, for example, wireless base stations and central office communications hubs that support wireless communications for wireless communications devices (e.g., wireless phones, wireless smartphones, wireless PDAs, and wireless gaming devices). Examples of some mobile network operators are AT&T Mobility, Verizon Wireless, T-Mobile, Virgin Mobile, etc. The mobile network operator may own and/or lease the infrastructure for providing mobile communications services and the mobile network operator has the ability to track the consumption of mobile communications services on a per-mobile subscriber and/or per-group basis. In an embodiment, consumption information can be obtained from the mobile network operator on a per-mobile subscriber and/or per-group basis. Although some details of the mobile network operator are provided herein, it should be noted that the mobile network operator may include various other functionality, systems, infrastructure, etc. as is known in the field of mobile network operations and wireless service providers. In an alternative embodiment, the mobile network operator as used herein may not actually operate the facilities of the mobile network, but may provide an interface between the mobile subscribers and the entity that operates the mobile facilities. For example, the mobile network operator as used herein may include an entity that leases mobile communications services from an underlying mobile network operator. Whether the mobile network operator owns the actual wireless communications facilities or leases mobile communications services, the mobile network operator is considered an entity that provides subscription-based (i.e., for fee) mobile communications services to mobile subscribers.

The mobile subscribers 104 consume mobile communications services such as wireless voice communications services, wireless data communications services, wireless video communications services, and wireless text communications services (i.e., text messaging). In an embodiment, the consumption of mobile communications services is tied to a particular mobile device (e.g., a Subscriber Identity Module (SIM) card within a mobile handset). In other embodiments, the consumption of mobile communications services is tied to a particular mobile subscriber (e.g., through a user account name and password). In other embodiments, the consumption of mobile communications services is tied to a combination of a mobile device and a mobile subscriber. As used herein, a mobile subscriber refers to any entity, person, group of people, device, and/or group of devices that holds the right to consume mobile communications services.

In accordance with an embodiment of the invention, the mobile credit intermediary 110 is an intermediary between the mobile subscribers 104 and the mobile network operator 102 that manages credit for mobile subscribers in a way that makes the credit more fungible than traditional prepaid mobile subscription plans that are offered by mobile network operators. In an embodiment, the mobile credit intermediary maintains a credit pool 112 that reflects pooled credit of a group of multiple different mobile subscribers and then incrementally purchases prepaid mobile minutes in quantities that reflect anticipated consumption of mobile communications services by the group. The incremental purchases of prepaid mobile communications services are made in increments that are smaller than the balance of the credit pool such that credit remains in individual credit accounts of the mobile subscribers. The credit that remains in the individual credit accounts of the mobile subscribers is allowed to be used by the mobile subscribers as a currency for other transactions, for example, for the purchase of goods and services from entities other than the mobile network operator. Because the purchase of prepaid mobile communications services is made in increments that are smaller than the credit pool balance, all of the credit in the individual credit accounts of the mobile subscribers is not immediately transferred to the mobile network operator, thereby leaving the credit outside of the control of the mobile network operator and available to the mobile subscribers as a liquid asset that can be used as currency to buy goods and services other than mobile communications services.

In an embodiment, the mobile credit intermediary 110 is a third-party that is separate and independent from the mobile network operator 102. For example, the mobile network operator is a separate corporation that has the ability to purchase prepaid mobile communications services from multiple different mobile network operators. Because the mobile credit intermediary is separate and independent from the mobile network operator, the mobile credit intermediary is free from some of the regulatory constraints of mobile network operators. Additionally, the independence enables a mobile subscriber to switch to a different mobile network operator without losing all of the credits in its individual credit account. In contrast, without the mobile credit intermediary, once a mobile subscriber 104 pays money to a mobile network operator, there is not much flexibility to subsequently transfer that money to a different mobile network operator. Further, because the mobile credit intermediary is a third-party that is separate and independent from the mobile network operator, individual accounts maintained by the mobile credit intermediary can continue to be maintained by the mobile credit intermediary even when the mobile subscriber changes mobile network operators or mobile phone numbers. This enables the mobile credit intermediary to act as a central hub for transactions by the mobile subscriber regardless of the mobile network operator.

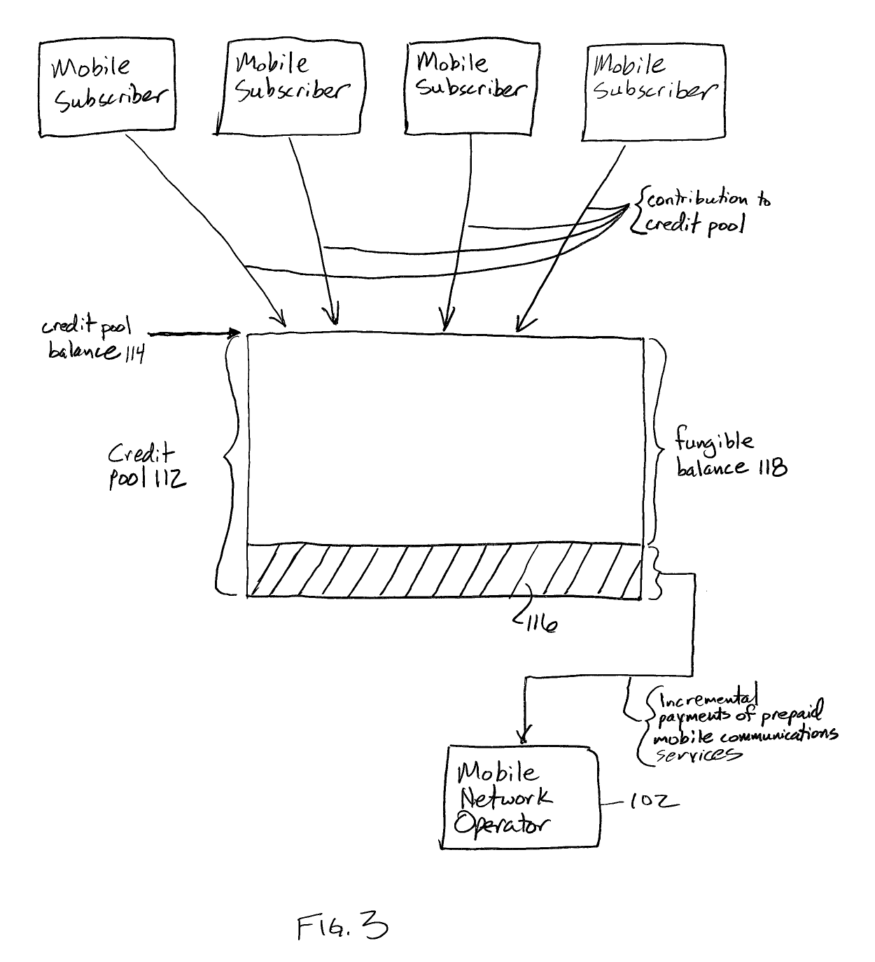

FIG. 3 illustrates a credit pool 112 that reflects the pooled credit of multiple different mobile subscribers 104. In an embodiment, the credit pool constitutes credit contributed from credit accounts of multiple different mobile subscribers. The credit pool has a credit pool balance 114 that represents the total credit value of all of the mobile subscribers that are associated with the credit pool. In an embodiment, a group of mobile subscribers are associated with a particular credit pool and the credit pool is funded from credit accounts of the mobile subscribers that make up the group. The credit pool can be valued in terms of a known currency, such as U.S. dollars, or some other proprietary or non-proprietary currency.

FIG. 3 also illustrates a portion 116 of the credit pool 112 (cross hatched portion) that is used to make an incremental purchase of prepaid mobile communications services (e.g., prepaid mobile minutes) from the mobile network operator. That is, some portion of the credit pool is used to make a purchase of prepaid mobile communications services from the mobile network operator. The size, frequency, and timing of the incremental purchases of prepaid mobile communications services are implementation specific. In an embodiment, the size, frequency, and timing of the incremental purchases are determined by predictive modeling, statistical analysis, past usage history, etc. Using predictive modeling it is possible to ensure that the immediate need for mobile communications services of the group is met without committing the entire balance of the credit pool to the mobile network operator in a single transaction.

Although a portion of the credit pool 112 is used for an incremental purchase of prepaid mobile communications services (e.g., mobile minutes) from the mobile network operator, the balance of the credit pool (referred to herein as the “fungible balance” 116), which is typically larger than the incremental purchase portion, remains available to mobile subscribers 104. The fungible balance can be used as currency for the purchase of other goods and services, for exchange with other account holders, for redemption for cash, for payment of other debts, and/or for loans. In particular, the fungible balance is not held by the mobile network operator and therefore can be used for any transactions supported by the mobile credit intermediary.

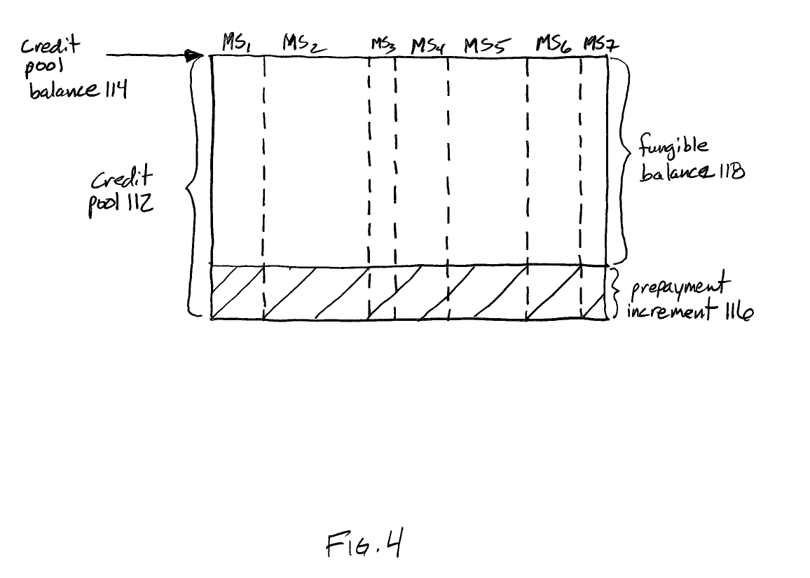

FIG. 4 illustrates an example embodiment of the distribution of credit amongst multiple different mobile subscribers that are associated with the credit pool 112. The area of the credit pool that is associated with each mobile subscriber is indicated by the dashed vertical lines and represents the relative credit balance of each mobile subscriber. As illustrated in FIG. 4, the credit balance of each mobile subscriber can be different. A portion of the credit balance of each mobile subscriber is used for the incremental purchase of mobile communications services and the magnitude of the portion can be the same for each mobile subscriber or different for each mobile subscriber depending on the specific implementation. As credit is used to purchase prepaid mobile communications services, the corresponding amount of credit is deducted from each mobile subscriber's individual credit account. As is described in more detail below, individual credit balances are reconciled based on the mobile subscriber's actual consumption of mobile communications services.

In an embodiment, different credit pools can be maintained for different groups of mobile subscribers. The different credit pools can be maintained simultaneously by the mobile credit intermediary. In an embodiment, credit pools are set up on a per-mobile network operator basis such that all of the credit accounts associated with the credit pool consume mobile communications services from the same mobile network operator. A wide range of criteria can be used to associate mobile subscribers with credit pools.

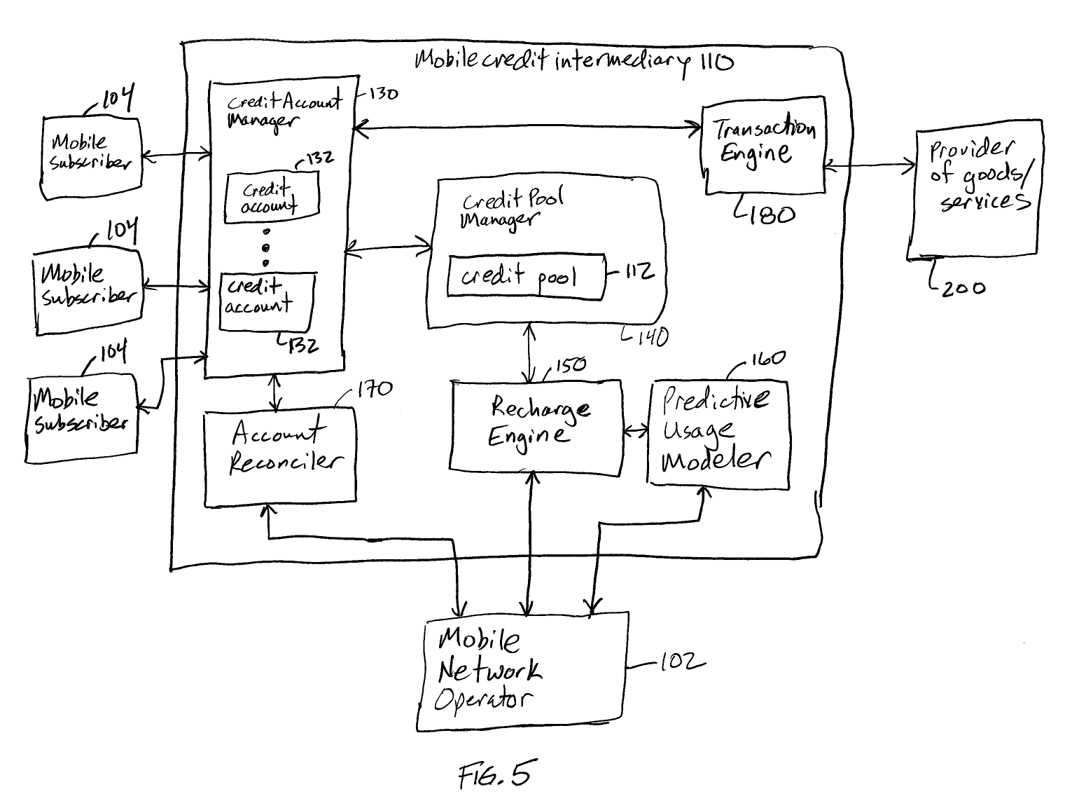

FIG. 5 illustrates an expanded view of an embodiment of the mobile credit intermediary 110 relative to multiple mobile subscribers 104 and the mobile network operator 102. In the embodiment of FIG. 5, the mobile credit intermediary includes a credit account manager 130, a credit pool manger 140, a recharge engine 150, a predictive usage modeler 160, an account reconciler 170, and a transaction engine 180.

FIG. 5 also depicts a provider 200 of other goods and/or services that is separate and independent from the mobile network operator 102. In an embodiment, the provider of goods and/or services provides goods and/or services other than mobile communications services. In an embodiment, these goods and/or services are any goods and/or services that can be purchased using an electronic transaction, including real goods and/or services and virtual goods and/or services.

The credit account manager 130 manages credit accounts 132 of the mobile subscribers. In an embodiment, each mobile subscriber 104 has an individual credit account that is specific to the particular mobile subscriber. In another embodiment, a mobile subscriber can be linked to more than one credit account and in another embodiment, multiple different mobile subscribers can be linked to the same credit account. A particular credit account is credited for deposits to the credit account and debited for withdrawals from the credit account. In an embodiment, credits to an account can be made based on the deposit of hard currency such as money (e.g., U.S. dollars, Euros, etc.) or based on earned credit that is earned by, for example, taking online surveys, viewing advertising, etc. Credit in an individual credit account can be, for example, used to purchase prepaid mobile communications services (e.g., prepaid mobile “airtime” or “minutes”) or used for transactions separate from the mobile network operator, e.g., to purchase goods and services from entities other than the mobile network operator, to give away, to pay off debt, or to loan out. Credit accounts can be accessed by the mobile subscribers using mobile devices and/or though web-based user interfaces. Additionally, credit account information can be pushed to the mobile subscribers using various techniques. In an embodiment, the credit account manager maintains real-time credit account balances for each credit account. The credit account manager also determines when a credit account is too low to be included in a credit pool. In an embodiment, the individual credit accounts are fungible accounts, similar to an escrow account, which remain external to the proprietary channels of the underlying mobile network operator until such a time that the credits are actually needed by the mobile subscriber, e.g., for the incremental purchase of prepaid mobile communications services. In an embodiment, a mobile subscriber that has credits in a credit account is referred to as a “credit account holder.”

The credit pool manager 140 manages credit pools. In an embodiment, the credit manager tracks the incremental purchases of prepaid mobile communications services using credit from a credit pool 112 and deducts credits from the credit pool when the incremental purchases are made. The credit pool manager can manage a single credit pool or can simultaneously manage multiple different credit pools. In one embodiment, a credit pool is funded on an as needed basis such that credit is added to the credit pool upon the initiation of an incremental purchase of prepaid mobile communications services. In an embodiment, a credit pool balance for a group of mobile subscribers does not reflect all of the credit in every individual credit account of the group and in another embodiment, the credit pool balance reflects the combined balances of all of the credit accounts that are associated with the credit pool. In an embodiment, mobile subscribers are grouped by common mobile network operator and credit is pooled from the credit accounts of the group and used to incrementally purchase prepaid mobile communications services from the corresponding mobile network operator.

The recharge engine 150 manages the incremental purchases of prepaid mobile minutes from the mobile network operator 102. The recharge engine interacts with the credit pool manager 140, the predictive usage modeler 160, and the mobile network operator to ensure that the credit accounts 132 associated with the credit pool have enough prepaid mobile minutes to meet the anticipated usage needs of the group of mobile subscribers that is associated with the credit pool. In an embodiment, the recharge engine uses information from the predictive usage modeler to determine when to purchase the needed prepaid mobile communications services (e.g., prepaid minutes). The recharge engine purchases prepaid mobile communications services in, for example, a stream of small, incremental payments, which leaves credit available in the individual credit accounts that are associated with the credit pool. The incremental purchase of prepaid mobile communications services provides liquidity to the unused credits in the corresponding credit pool and liquidity to the credit accounts of the corresponding mobile subscribers. The recharge engine may use a variety of different information to determine the size, frequency, and/or timing of purchases of prepaid mobile communications services. The information may include, for example, modeling information, past usage history, and user notification.

The predictive usage modeler 160 predicts and/or anticipates the future consumption of mobile communications services by the group of mobile subscribers 104 that are associated with the credit pool 112. The predictions are used by the recharge engine 150 to determine the size, frequency, and timing of the incremental purchases of prepaid mobile communications services. The future consumption of mobile communications services may be predicted and/or anticipated based on, for example, statistical modeling, past usage history or any other information that is available to help predict and/or anticipate future demand for mobile communications services. In an embodiment, the predictive usage modeler uses direct feedback from the mobile network operator on actual usage by the mobile subscribers that hold the credit accounts. Feedback may include how often mobile subscribers make calls, in what increments they purchase prepaid mobile communications services, and how often they “top-up” their prepaid mobile communications account.

The number of mobile subscribers associated with a credit pool is a significant factor in how well future demand can be predicted. In an embodiment, the accuracy of the predictions increases as the number of mobile subscribers associated with the credit pool increases. In an embodiment, the ideal number of mobile subscribers associated with a credit pool depends on behavioral characteristics of the mobile subscribers and the desired degree of fungibility of the credit in the credit accounts. In general, the greater the number of mobile subscribers associated with a credit pool and the more broadly consistent their usage pattern, the greater percentage of credit that can be left in the credit pool, i.e., not used for the purchase of prepaid mobile communications services.

The predictive usage modeler 160 can apply different prediction techniques and provide different predictions for different groups of mobile subscribers. In an embodiment, credit pools can be formed from a group of mobile subscribers with a similar characteristic, for example, a characteristic that makes it easier to anticipate the consumption of mobile communications services by the group.

The account reconciler 170 supports the tracking of the individual consumption of mobile communications services by the mobile subscribers 104. In an embodiment, the account reconciler obtains individual consumption information from the mobile network operator 102 and provides the information to the credit account manager 130 so that the credit account manager can make the appropriate balance adjustments to the individual credit accounts 132 associated with the mobile subscribers. The information that is obtained from the mobile network operator includes, for example, the number of minutes consumed by each mobile subscriber, the type of minutes consumed (e.g., peak minutes, off-peak minutes), the amount of data services consumed (e.g., kilobytes transferred), the number of text messages sent or received, the frequency at which mobile subscribers purchase prepaid mobile communications services, and/or the quantities of mobile communications services that are purchases (e.g., 150 minutes for $15.00 or 200 minutes for $20.00). In an embodiment, the account reconciler also tracks participation in advertising promotions (e.g., offers, surveys, videos, etc.) that occur on behalf of the credit accounts. In an embodiment, the consumption information is obtained through an electronic data transmission, such as a remote method invocation over HTTP. In an embodiment, the account reconciler determines the actual usage by each mobile subscriber associated with a particular credit pool in order to properly debit the corresponding individual credit accounts. Unused credits, i.e., credits thus far not consumed by the mobile subscriber, remain fungible to the holder of the credit account.

The transaction engine 180 enables the mobile credit intermediary 110 to conduct transactions with other entities using the credit in the independent credit accounts 132 as currency. In particular, the transaction engine enables credit account holders (i.e., the mobile subscribers) to use the outstanding credit balances in their credit accounts to purchase goods and services other than mobile communications services. In an embodiment, the transaction engine is configured to avoid double-counting of credits, for example, through a two-step authorization and fulfillment process. In an embodiment, the transaction engine also enables mobile subscribers to exchange credits amongst each other.

With reference to FIG. 5, in operation, a mobile subscriber 104 obtains credit that is applied to the individual credit account 132 of the mobile subscriber. The credit manager 130 includes the mobile subscriber in a group of mobile subscribers that is associated with a credit pool 112. In particular, credit accounts of the mobile subscribers in the group are associated with the credit pool and contribute credit to the credit pool. The credit pool manager 140 maintains the balance of the credit pool. The predictive usage modeler 160 predicts the consumption of mobile communications services by the group of mobile subscribers and the recharge engine 150 uses the prediction to determine the size, frequency, and timing of incremental purchases of prepaid mobile communications services on behalf of the group of mobile subscribers. The recharge engine incrementally purchases, using credit from the credit pool, prepaid mobile communications services from the mobile network operator in a stream of incremental payments that are small enough such that credit remains in the individual credit accounts of the mobile subscribers. The account reconciler 170 receives actual usage information from the mobile network operator 102 and deducts credit from the individual credit accounts in response to the actual usage information. In particular, the account reconciler ensures that the corresponding credit accounts are each charged only for the mobile communications services that are consumed by the corresponding mobile subscriber. Credit that remains in the individual credit accounts of the mobile subscribers is available to the mobile subscribers to use as currency for other transactions, for example, transactions that are independent of the mobile network operator.

A simplistic example of the above-described operation is as follows. The credit accounts of ten mobile subscribers are associated with a credit pool. The mobile subscribers each deposit $100 per month into their credit accounts but consume only $25 per month of mobile communication services. The total value of the monthly deposits is $1,000 per month but the usage equates to only $250 per month. In this scenario, the credit pool starts with a credit pool balance of $1,000 and purchases of prepaid mobile communications services are made in increments of roughly $250 per month. This leaves the remaining $750 (or $75 per account) available in the corresponding credit accounts of the mobile credit intermediary. The remaining credit can be used by the credit account holders for transactions that are independent of the mobile network operator. Of course, the credit accounts of the corresponding mobile subscribers are “charged” for the actual usage such that if a mobile subscriber exceeds the average $25 per month usage, the mobile subscriber's credit account will be adjusted accordingly. The pooling of credit and the incremental purchase of prepaid mobile communications services on behalf of the credit pool enables a mobile subscriber to have its credit dedicated to the purchase of prepaid mobile communications services on an as-consumed basis that is in line with the actual usage of the mobile subscriber. For example, if the mobile subscriber consumes all $100 worth of mobile communications services in a month, then all $100 goes to pay for the consumed mobile communications services and if the mobile subscriber consumes only $15 in a month, then the mobile subscriber is left with $85 of fungible credits in their credit account. In effect, the mobile subscriber uses a prepaid mobile communications subscription plan but pays only for the prepaid mobile communications services that the mobile subscriber actually consumes.

The above described technique for managing credit for mobile subscribers can: 1) enable a consumer to buy prepaid minutes (for mobile “airtime”), which can be utilized on multiple mobile phones, spanning multiple different mobile network operators and users; 2) enable a consumer to transfer prepaid minutes between multiple mobile phone accounts, mobile network operators and other users; 3) enable a consumer to redeem prepaid minutes back into cash, including prepaid minutes transferred from other users, by transferring prepaid minutes back into a cash-based account that is linked with the prepaid credit account of a mobile subscriber; 4) offer interest for prepaid minutes on deposit in a credit account; 5) effectively offer prepaid minutes that never expire; and 6) offer “overdraft” services for credit account holders.

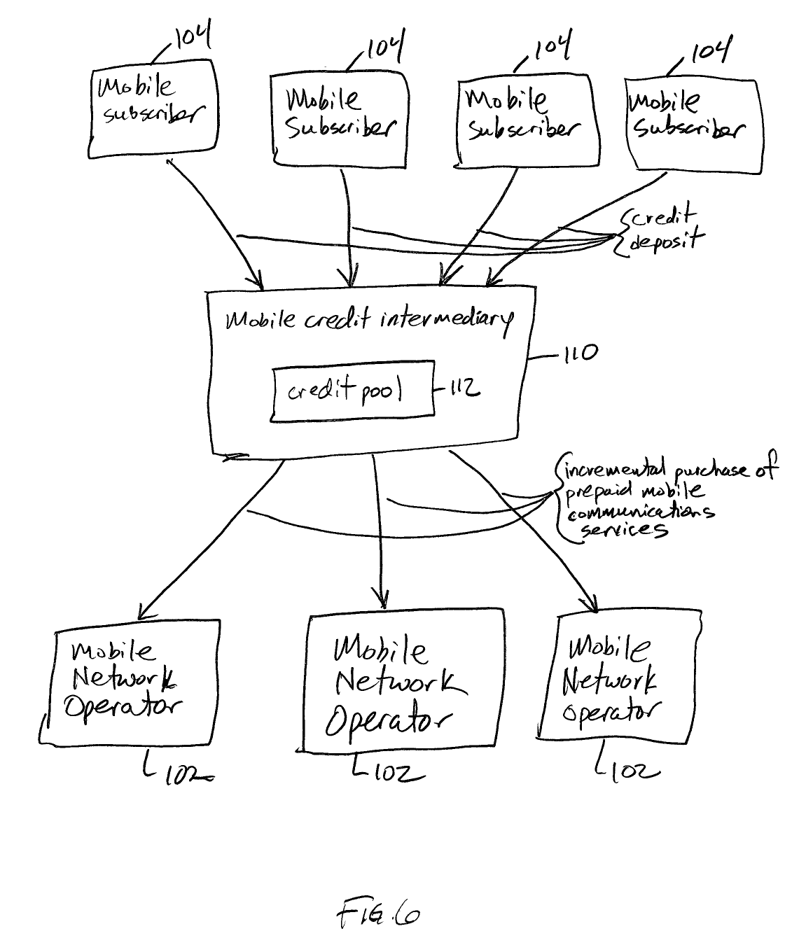

FIG. 6 illustrates a system for managing credit for mobile subscribers 104 in which prepaid mobile communications services are incrementally purchased by a mobile credit intermediary 110 from a credit pool 112 that includes credit from a group of mobile subscribers in accordance with an embodiment of the invention. In the embodiment of FIG. 6, the mobile credit intermediary can purchase prepaid mobile communications services from multiple different mobile network operators 102. As described above, mobile subscribers may be grouped by mobile network operator such that all of the members of the group use the same mobile network operator to obtain mobile communications services. Credit from a credit pool that is associated with the group is then used to purchase prepaid mobile communications services from the corresponding mobile network operator. Additionally, as described above, the mobile credit intermediary enables a mobile subscriber to switch from one mobile network operator to another mobile network operator without losing all of the credit that the mobile subscriber has in its individual account. This is possible because mobile communications services are incrementally purchased for a group of mobile subscribers in relatively small amounts based on the anticipated consumption of mobile communications services, thereby leaving some of the credit remaining in the individual credit accounts of the mobile subscribers. In an embodiment, funds (i.e., credit) originally authorized for prepaid mobile credits on one mobile network could be exchanged, at some “exchange rate,” for prepaid mobile minutes on another mobile network. In other words, minutes from one credit pool could be exchanged for minutes in another credit pool and the credit account of the mobile subscriber is changed from being associated with one credit pool to being associated with a different credit pool.

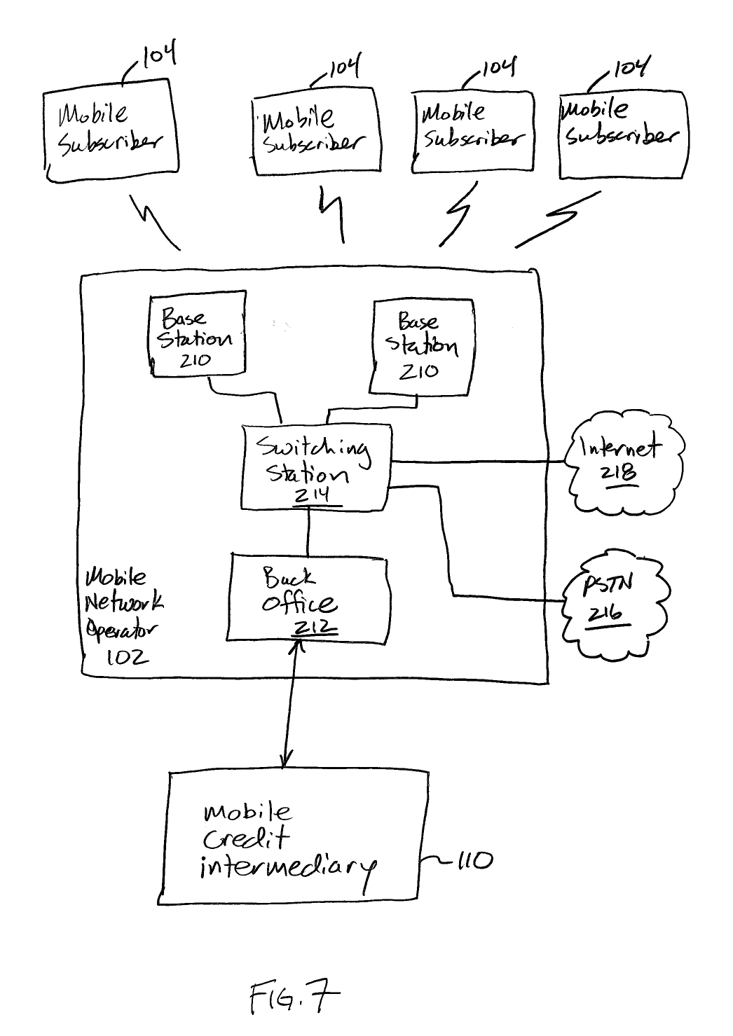

FIG. 7 depicts a mobile credit intermediary 110, multiple mobile subscribers 104, and a mobile network operator 102. The mobile network operator includes at least one base station 210, a back office 212, and a switching station 214 that is connected to a publically switched telephone network (PSTN) 216 and the Internet 218. The base stations provide radio frequency communications between the mobile subscribers and the mobile network operator, the switching station provides communications switching, and the back office provides support functions (e.g., subscriber management, account reconciliation, usage tracking, etc) for the mobile network operator. Although FIG. 7 depicts basic elements of a mobile network operator, mobile network operators may include more, fewer, and/or different elements as is known in the field. Mobile network operators are well known in the field and are not described in detail herein.

In the embodiment of FIG. 7, the mobile credit intermediary 110 is connected to the back office 212 of the mobile network operator 102. The connection to the back office enables the mobile credit intermediary to purchase prepaid mobile communications services from the mobile network operator and to obtain usage information from the mobile network operator as described above. Although the mobile credit intermediary is described as being connected to the back office of the mobile network operator, any connection that enables the mobile credit intermediary to obtain the necessary information and to carry out the above described tasks is possible.

In an embodiment, a credit pool 112 can be set up for a single mobile subscriber and mobile communications services can be incrementally purchased on behalf of the single mobile subscriber.

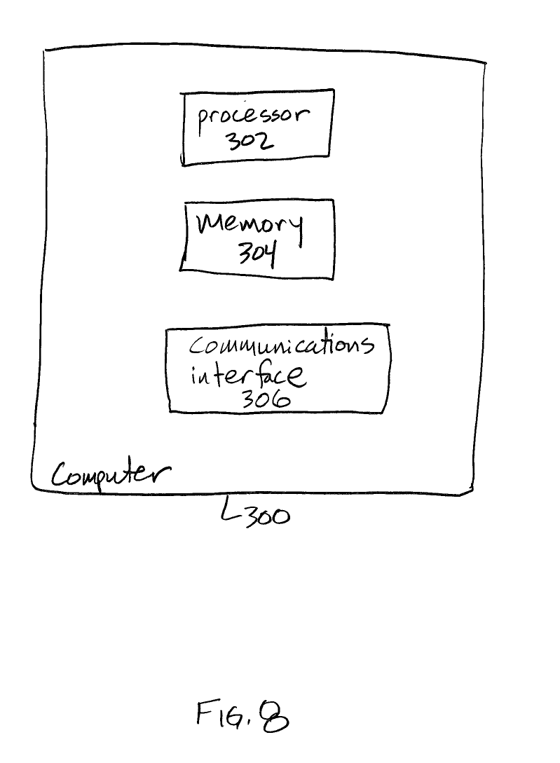

In an embodiment, the functionality of the mobile credit intermediary is performed by a computer that executes computer readable instructions (software). FIG. 8 depicts a computer 300 that includes a processor 302, memory 304, and a communications interface 306. The processor may include a multifunction processor and/or an application-specific processor. Examples of processors include the PowerPC™ family of processors by IBM and the ×86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

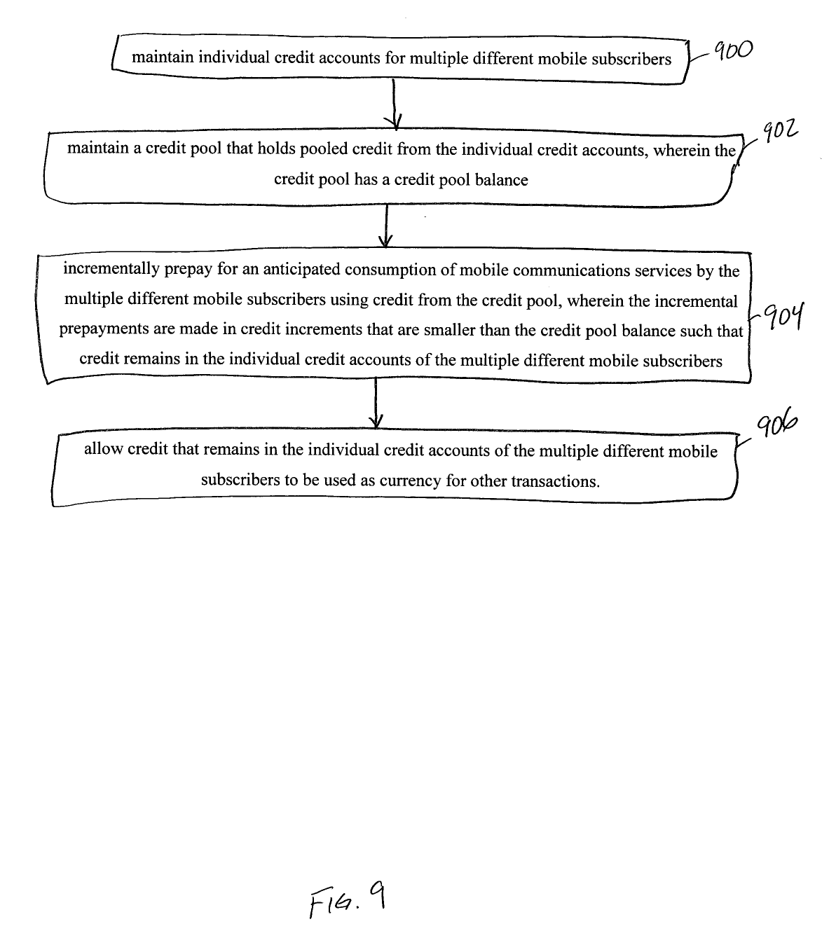

FIG. 9 is a process flow diagram of a method for managing credit for mobile subscribers in accordance with an embodiment of the invention. At block 900, individual credit accounts are maintained for multiple different mobile subscribers. At block 902, a credit pool that holds pooled credit from the individual credit accounts is maintained, wherein the credit pool has a credit pool balance. At block 904, an anticipated consumption of mobile communications services by the multiple different mobile subscribers is incrementally paid for using credit from the credit pool, wherein the incremental prepayments are made in credit increments that are smaller than the credit pool balance such that credit remains in the individual credit accounts of the multiple different mobile subscribers. At block 906, credit that remains in the individual credit accounts of the multiple different mobile subscribers is allowed to be used as currency for other transactions.

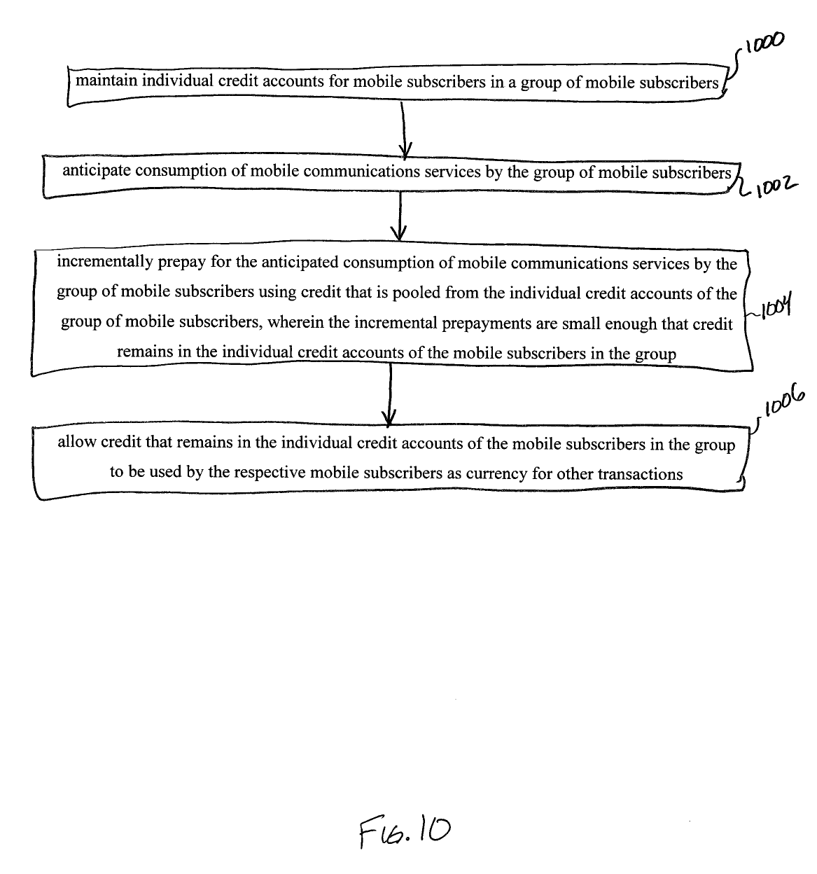

FIG. 10 is a process flow diagram of another method for managing credit for mobile subscribers in accordance with an embodiment of the invention. At block 1000, individual credit accounts are maintained for mobile subscribers in a group of mobile subscribers. At block 1002, consumption of mobile communications services by the group of mobile subscribers is anticipated. At block 1004, the anticipated consumption of mobile communications services by the group of mobile subscribers is incrementally prepaid for using credit that is pooled from the individual credit accounts of the group of mobile subscribers, wherein the incremental prepayments are small enough that credit remains in the individual credit accounts of the mobile subscribers in the group. At block 1006, credit that remains in the individual credit accounts of the mobile subscribers in the group is allowed to be used by the respective mobile subscribers as currency for other transactions.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the above-described techniques are described in a general context, those skilled in the art will recognize that the above-described techniques may be implemented in software, hardware, firmware or any combination thereof. The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform the method in accordance with an embodiment of the present invention. The computer readable media may comprise, for example, RAM (not shown) contained within the computer. Alternatively, the instructions may be contained in another computer readable media such as a magnetic data storage diskette and directly or indirectly accessed by a computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

The above-described techniques enable the purchase, sale, and exchange of mobile network credit (e.g., prepaid mobile minutes) in a way that is not tightly coupled with any specific mobile network operator. Further, the credit (e.g., the prepaid mobile minutes) is effectively converted into an exchangeable and liquid commodity that can serve as a de facto currency for a broad array of transactions, including the purchase of goods and services. This can benefit businesses and consumers by minimizing the irreversible outlays of money and maximizing the flexibility of funds deposited for the purpose of maintaining prepaid mobile phone subscription plans.

Although specific embodiments of the invention have been described and illustrated, the invention is not to be limited to the specific forms or arrangements of parts as described and illustrated herein. The invention is limited only by the claims.

What is claimed is:

1. A method for managing credit for mobile subscribers, the method comprising:
maintaining individual credit accounts for multiple different mobile subscribers;
maintaining a credit pool that holds pooled credit from the individual credit accounts, wherein the credit pool has a credit pool balance;
incrementally prepaying for an anticipated consumption of mobile communications services by the multiple different mobile subscribers using credit from the credit pool, wherein the incremental prepayments are made in credit increments that are smaller than the credit pool balance such that credit remains in the individual credit accounts of the multiple different mobile subscribers; and
allowing credit that remains in the individual credit accounts of the multiple different mobile subscribers to be used as currency for other transactions.

2. The method of claim 1 further comprising allowing credit that remains in the individual credit accounts of the multiple different mobile subscribers to be exchanged between mobile subscribers.

3. The method of claim 1 further comprising allowing credit that remains in the individual credit accounts of the multiple different mobile subscribers to be exchanged between credit accounts.

4. The method of claim 1 further comprising anticipating consumption of mobile communications services by the multiple different mobile subscribers.

5. The method of claim 4 wherein the consumption is anticipated on a group basis for the multiple different mobile subscribers that are associated with the credit pool.

6. The method of claim 5 wherein the incremental prepayments secure mobile communications services that can be consumed by the mobile subscribers that are associated with the credit pool.

7. A method for managing credit for mobile subscribers, the method comprising:
maintaining individual credit accounts for mobile subscribers in a group of mobile subscribers;
anticipating consumption of mobile communications services by the group of mobile subscribers;
incrementally prepaying for the anticipated consumption of mobile communications services by the group of mobile subscribers using credit that is pooled from the individual credit accounts of the group of mobile subscribers, wherein the incremental prepayments are small enough that credit remains in the individual credit accounts of the mobile subscribers in the group; and
allowing credit that remains in the individual credit accounts of the mobile subscribers in the group to be used by the respective mobile subscribers as currency for other transactions.

8. The method of claim 7 further comprising allowing credit that remains in the individual credit accounts of the multiple different mobile subscribers to be exchanged between mobile subscribers.

9. The method of claim 7 wherein anticipating consumption of mobile communications services by the group comprises using predictive modeling.

10. The method of claim 7 wherein anticipating consumption of mobile communications services by the group comprises considering past usage history of the mobile subscribers in the group.

11. The method of claim 7 further comprising:
obtaining usage information that indicates actual usage of mobile communications services by mobile subscribers in the group; and
adjusting the individual credit accounts of the mobile subscribers in the group in response to the obtained usage information.

12. The method of claim 11 wherein the usage information is obtained from a mobile network operator that provides prepaid mobile communications services to the mobile subscribers in the group.

13. The method of claim 7 further comprising using credit that remains in the individual credit accounts of the mobile subscribers in the group as currency to complete a transaction with a provider of goods or services that is independent of the mobile network operator.

14. A system for managing credit for mobile subscribers, the system comprising:
a mobile credit intermediary that interfaces between multiple different mobile subscribers and a mobile network operator, the mobile credit intermediary comprising;
a credit account manager configured to maintain individual credit accounts for the multiple different mobile subscribers;
a credit pool manager configured to maintain a credit pool that holds pooled credit from the individual credit accounts, wherein the credit pool has a credit pool balance;
a predictive usage modeler configured to anticipate consumption of mobile communications services by the multiple different mobile subscribers;
a recharge engine configured to incrementally prepay the mobile network operator for the anticipated consumption of mobile communications services by the multiple different mobile subscribers using credit from the credit pool, wherein the incremental prepayments are made in credit increments that are smaller than the credit pool balance such that credit remains in the individual credit accounts of the multiple different mobile subscribers;
an account reconciler configured to deduct credit from the individual credit accounts in response to actual consumption of mobile communications services; and
a transaction engine configured to allow credit that remains in the credit accounts of the multiple different mobile subscribers to be used by the multiple different mobile subscribers as currency for other transactions.

15. The system of claim 14 wherein the mobile credit intermediary is independent of the mobile network operator.

16. The system of claim 14 the credit that remains in the credit accounts of the multiple different mobile subscribers is a fungible currency.

17. The system of claim 14 wherein the predictive usage modeler obtains usage information from the mobile network operator that indicates actual usage of the multiple different mobile subscribers and uses the usage information to anticipate consumption of mobile communications services by the multiple different mobile subscribers.

18. The system of claim 14 wherein the account reconciler obtains usage information from the mobile network operator that indicates actual usage of the multiple different mobile subscribers and adjusts the individual credit accounts in accordance with the usage information.

19. The system of claim 14 wherein the transaction engine enables the credit that remains in the credit accounts of the multiple different mobile subscribers to be used by the multiple different mobile subscribers as currency for transactions with a provider of goods or services that is independent of the mobile network operator.
